(19) United States
(12) Patent Application Publication
(10) Pub. No.: US 2025/0327906 A1
(43) Pub. Date: Oct. 23, 2025

(54) Detection system integrated with power management module

(71) Applicant: Ningbo ABAX Sensing Electronic Technology Co., Ltd., Zhejiang (CN)

(72) Inventor: Shuyu LEI, Ningbo City, Zhejiang Province (CN)

(73) Assignee: Ningbo ABAX Sensing Electronic Technology Co., Ltd., Ningbo City, Zhejiang Province (CN)

(21) Appl. No.: 18/270,298

(22) PCT Filed: Dec. 10, 2021
(86) PCT No.: PCT/CN2021/137029

§ 371 Date: Jul. 9, 2024

(30) Foreign Application Priority Data
Dec. 29, 2020 (CN) 202011588436.9

(51) Int. Cl. G01S 7/4863; G01S 7/481; G01S 7/484

(52) U.S. Cl. CPC G01S 7/4863; G01S 7/4816; G01S 7/484

(57) ABSTRACT

Provided is a detection system integrated with a power management module, comprising: an emitting end, the emitting end comprising a driver integrated circuit; an integrated array-type receiving end comprising at least some subsequent circuits, and configured to receive a return optical signal formed by reflecting, by means of a detection object in a field of view, emergent light emitted by the emitting end, and convert the return optical signal into an electrical signal; and a power management module, which outputs at least a driving voltage required by the emitting end and a working voltage of a receiving array unit, the power management module being integrated with the driver integrated circuit or the array-type receiving end to form a modular structure.

### CROSS REFERENCE TO RELATED APPLICATIONS

The present application claims priorities to Chinese Patent Application No. CN 202011588436.9, titled “Detection system integrating a power management module”, filed on Dec. 29, 2020 with the Chinese Patent Office, which are incorporated herein by reference in their entireties.

### FIELD

The present disclosure relates to the field of detection technology, and in particular, to a detection system integrating a power management module.

### BACKGROUND

Time-of-flight (TOF) technology has been developed as a method for measuring the distance to an object in a scene. The TOF technology can be applied in various fields, such as automotive industry, human-machine interface and gaming, robotics, etc. Generally speaking, the working principle of TOF technology is to emit a modulated light from a light source to illuminate the scene and observe the reflected light from objects in the scene. To ensure higher detection efficiency and wider field of view in existing detection systems, an array-type receiving module is commonly used. The array-type receiving module has thousands of pixel units, each of which can be a diode such as CCD or CMOS. This is just an example, and it is not limited to the type of diode used to form the pixel unit.

The array type receiving module is usually arranged on the focal plane of the optical (lens) system, so the array type receiving module is also called a focal plane array receiving module. With the increasing requirements for chip miniaturization and high integration, the system also require various voltage modes. For example, in a single-photon avalanche diode array detection system, in order to ensure high sensitivity detection of the detector, a reverse bias voltage higher than the avalanche threshold needs to be applied, such as a reverse bias voltage greater than 20V. In addition, for some quenching schemes such as active quenching method, it is also necessary to ensure fast quenching of the avalanche diode, which requires a reliable clamping voltage such as 18V and so on. In another scenario, such as in ITOF ranging, there are precision requirements for the driving voltage. For example, the power supply voltage requirement for the laser emitter is 3.3V with a precision requirement of no more than 1% deviation. While the power supply voltage for the detection array unit is usually 3.6V, which is different from the power supply voltage required by the laser emitter. In addition, the analog signal adjustment circuit included in the detection system (such as the “analog front end” or AFE) also requires different driving voltages, such as row selection driving voltage and so on. In many scenarios, the actual input power supply cannot meet the diverse voltage requirements of the detection system. So it is necessary to develop a detection system with a centralized voltage configuration function that can not only meet the detection requirements of the detection system, achieve higher integration and miniaturization requirements of the detection system, but also ensure the controlling accuracy in the system and ensure the efficient and reliable detection results output.

### SUMMARY

Based on this, a detection system integrating a power management module is provided in the present disclosure to solve the technical problem in the prior art that the input power supply cannot meet the voltage requirements of the detection system for different types of power supply voltages simultaneously.

Technical solutions in embodiments of the present disclosure are provided as follows.

A detection system integrating a power management module is provided according to an embodiment of the present disclosure. The detection system integrating a power management module including an emitting end, where the emitting end includes a driver integrated circuit; an integrated array-type receiving end, which includes at least some subsequent circuits, is used to receive the retuned light signals and then convert the light signals into electrical signals, where the retuned light is the emitting light from the emitting end and reflected by the detected object in the field of view; and a power management module, which outputs at least the driving voltage required by the emitting end and the working voltage of the receiving array unit; the power management module and the driving integrated circuit or the array-type receiving end are integrated to form a modular structure.

In an embodiment, the power management module and the driver integrated circuit are integrated to form the modular structure, and the power management module and the driver integrated circuit are packaged into an integral modular structure.

In an embodiment, the power management module and the array-type receiving end are integrated to form the modular structure, and the power management module and the array-type receiving end are packaged into an integral modular structure.

In an embodiment, the receiving array unit is a single photon avalanche diode, and the working voltage of the receiving end output by the power management module is greater than the threshold voltage of the single photon avalanche diode.

In an embodiment, the driving voltage output by the power management module is adjustable.

In an embodiment, the working voltage of the receiving array unit output by the power management module is adjustable.

In an embodiment, the power management module further includes a common communication interface unit, and the communication interface unit is further configured to provide a communication connection for the driving integrated circuit or the array-type receiving end.

In an embodiment, the power management module further outputs at least a third output voltage with a third voltage value.

In an embodiment, the power management module includes a linear power supply unit and/or a switching power supply unit.

In an embodiment, the power management module further includes an extended voltage output unit.

The beneficial effects of this disclosure are:

A detection system integrating a power management module provided by an embodiment of the present disclosure including an emitting end, where the emitting end includes a driver integrated circuit; an integrated array-type receiving end, which includes at least some subsequent circuits, is used to receive the retuned light signals and then convert the light signals into electrical signals, where the retuned light is the emitting light form the emitting end reflected by the detected object in the field of view; and a power management module, which outputs at least the driving voltage required by the emitting end and the working voltage of the receiving array unit; the power management module and the driving integrated circuit or the array-type receiving end are integrated to form a modular structure, according to the detection system of the present disclosure, the different voltage requirements of the detection system can be designed in a unified and integrated manner, and the different voltage can be uniformly distributed by the power management module, further the power management module and the driving integrated circuit or the array-type receiving end are integrated to form a modular structure, so that the entire design realizes the diversification of system functions, achieves different detection requirements, and ensures the miniaturization of the entire system.

### BRIEF DESCRIPTION OF THE DRAWINGS

In order to illustrate the technical solutions of the embodiments of the present disclosure more clearly, the drawings used for the embodiments are briefly introduced in the following. It should be understood that the following drawings only show some embodiments of the present disclosure, and should not be regarded as a limitation of the scope. Other drawings may be obtained by those skilled in the art from these drawings without any creative work.

FIG. 1 is a schematic diagram showing the detection system in the prior art;

FIG. 2 is a schematic diagram showing an integrated power management module in a driving part of an emitting end according to an embodiment of the present disclosure;

FIG. 3 is a schematic diagram showing an integrated power management module at a receiving end according to an embodiment of the present disclosure;

FIG. 4 is a functional diagram showing a power management module according to an embodiment of the present disclosure;

FIG. 5 is a schematic diagram showing a power management module providing different voltage outputs in a DTOF detection system according to an embodiment of the present disclosure;

FIG. 6 is a schematic diagram showing an array-type receiving end according to an embodiment of the present disclosure;

### DETAILED DESCRIPTION OF EMBODIMENTS

In order to make the purposes, technical solutions and advantages of the embodiments of the present application clearer, the technical solutions in the embodiments of the present application will be described clearly and completely below with reference to the drawings in the embodiments of the present disclosure. Apparently, the described embodiments are some but not all embodiments of the present disclosure. Components of the embodiments generally described and illustrated in the drawings herein may be arranged and designed in a variety of different configurations.

Therefore, the following detailed description for the embodiments of the present disclosure provided in the drawings is not intended to limit the scope of the present disclosure as claimed, but is merely representative of selected embodiments of the present disclosure. Based on the embodiments in the present disclosure, all other embodiments obtained by those skilled in the art without creative work shall fall in the protection scope of the present disclosure.

It should be noted that, similar numerals and letters refer to similar items in the following drawings. Therefore, if an item is defined in a drawing, the item is not required to be further defined and explained in subsequent drawings.

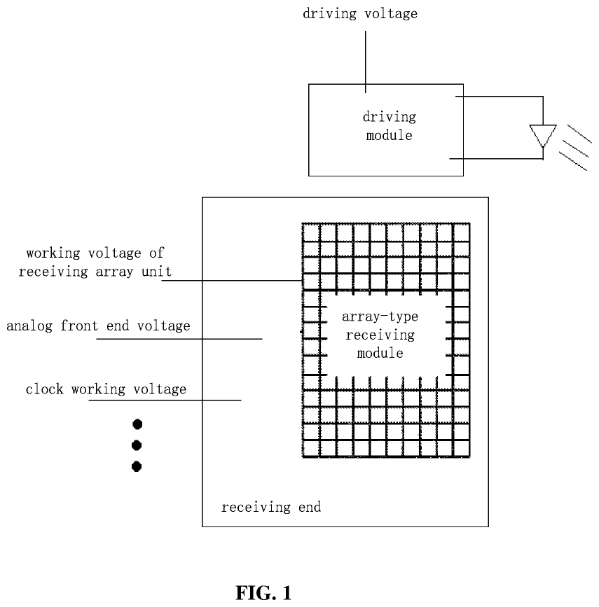

The detection system in the prior generally includes an emitting end and an array-type receiving end, and the emitting end may include but not limited to semiconductor lasers, solid-state lasers, and other types of lasers. When a semiconductor laser is used as the light source, a vertical-cavity surface-emitting laser VCSEL or an edge-emitting semiconductor laser EEL can be used, which is only illustrative and not limited herein. The light emitting module at the emitting end emits sine waves, square waves or triangle waves, etc. In ranging applications, most of them are lasers with a certain wavelength, such as 950 nm infrared lasers (optimally near-infrared lasers). The emitted light is projected into the field of view, and the detected object in the field of view can reflect the projected laser light to form returned light, which enters the detection system and is captured by the receiving end. The receiving end includes a receiving module arranged in an array, which can include a photoelectric conversion part, such as an array sensor composed of CMOS, CCD, etc., and can also include multiple lenses, which can form more than one image plane, that is said the receiving module contains more than one image plane, and the photoelectric conversion part of the receiving module is located at one of the image planes, which can be received by the most commonly used four-phase scheme to obtain 0°, 90°, 180° and 270° delay reception of the signal. Of course, the receiving module may also be an array-type unit composed of avalanche diode units that can be applied with a reverse bias voltage higher than the threshold voltage. The signal converted by the photoelectric conversion part in the diode array needs to rely on the combination of analog circuit and digital circuit to output the result converted into final information. Generally speaking, the voltage requirements of digital circuits are relatively uniform in design, but due to the requirements of analog circuit devices themselves, different functional modules require different voltages, and there are special requirements for the accuracy of the output voltage in some special scenarios. As shown in FIG. 1, in order to ensure the normal operation of the detection system, the emitting end and the receiving end each has a voltage supply unit. For example, the driving module needs the driving voltage to ensure the driving module outputs the excitation signal for the photodiode, to complete the output of the light signal at the emitting end. The array-type receiving module at the receiving end needs working voltage to ensure the conversion of photoelectric signals and the transmission of signals. In addition, it also needs the cooperation of analog circuits to ensure the transmission of signals. Further, the clock working circuit needs driving voltage, etc. Of course, that some circuits can use the voltage provided by the device of the detection system, however, but for the voltage that cannot provided by the device which requires complex design in the prior art which will cause great waste, and may cause changes in some parts that have been designed, even in some cases, the layout of the corresponding modules cannot be realized under the requirements of the existing system size.

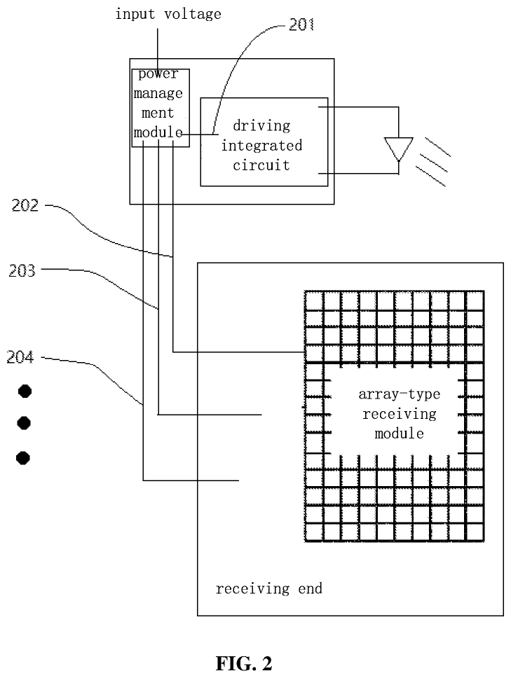

FIG. 2 is a detection system with an improved structure provided by the disclosure, for the voltage that cannot be provided by the device the system has an integrated design, that is, the voltages of other specifications are organized into a unified module, which can achieve different voltage value and output different precision voltages, then more and more comprehensive functional designs can be achieved under the premise of miniaturizing design of the entire detection system. In order to realize the integration of the power management module in the system, a hybrid integrated circuit technology can be used. The main idea of this scheme is to design the driver integrated circuit and power management module in FIG. 2 separately, and then collect the independently designed power modules with the substrate of the power management module as the substrate, so that the power management module and driver integrated circuit are packaged as an integral modular structure. Another implementation scheme is to design the circuit components of the driver integrated circuit and the power management module directly on the same substrate, to realize the overall design scheme, and then the power management module and the driver integrated circuit are packaged as an overall modular structure through subsequent packaging. The actual production is not limited to the above mentioned two solutions. The final result is that the power management module of the laser is integrated with the driver integrated circuit, and the design becomes a whole design, and only the operating voltage required by the power management module needs to be provided externally. Such a structure realizes the modular design idea, and also realizes the flexible design and better stability. The power management module can output the voltage 201 for the operation of the driving integrated circuit, and can also output the voltage 202 for the operation of the array type receiving module, for example, the voltage exceeding the avalanche threshold in the DTOF array, which can be the voltage exceeding 20V, or The working voltage of the unit in the ITOF can be 3.6V, etc., which is not limited here. The power management module can also output other voltages 203 and 204 other than the above mentioned two voltages, such as clamping voltage in DTOF operation, other voltages in analog circuits, etc., which are not limited here.

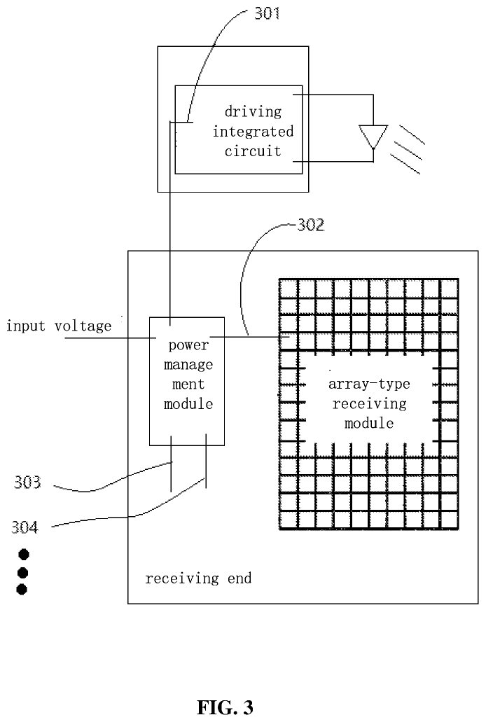

FIG. 3 is another detection system with an improved structure provided by the disclosure. The difference from FIG. 2 is that the power management module in this embodiment is integrated at the array-type receiving end to form a modular structure. The packaging scheme to form a modular structure of packaging in the manner similar to that shown in FIG. 2, which is not limited here, but the implementation method in FIG. 2 is more preferable. The main reason is that using the method shown in FIG. 3, operations in the power module can generate switch instant change which may couple to other parts of the detection system, such as the noise will be introduced during the capture of one or more actual scene information or during the acquisition of previously captured discrete-time distance information (e.g., readout and sampling),that the noise may be detrimental to the user, for example presenting unwanted artifacts in the acquired information, the signal-to-noise ratio is reduced in other applications such as spectral or time-of-flight imaging, or in the final information obtained in low light conditions, and the integration of the power management module in the receiving end in the design has this problem more or less. The disclosure does not exclude the solution of integrating the power management module at the receiving end, but the problem can be reduced or even eliminated by isolating circuits or signal processing.

It is worth noting that in the method of FIG. 3, which is similar to the method of FIG. 2, the power management module can output the voltage 301 required for the operation of the driving integrated circuit, and can also output the voltage 302 required for the operation of the array-type receiving module, for example, the voltage exceeding the avalanche threshold in the DTOF array, which may be a voltage exceeding 20V, or the unit operating voltage in the ITOF, which may be 3.6V, etc., which are not limited here. The power management module can also output other voltages 303 and 304 other than the above two mentioned voltages, such as clamping voltage in DTOF operation, other voltages in analog circuits, etc., which are not limited here.

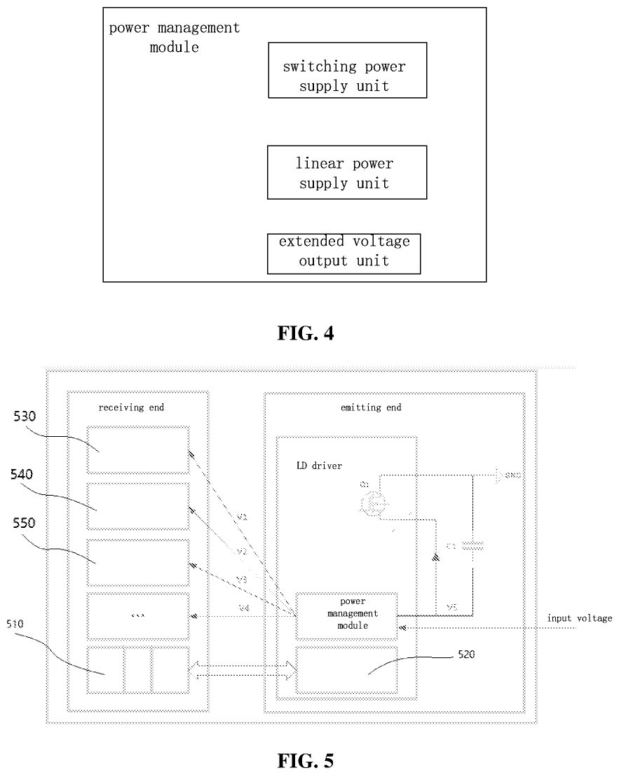

FIG. 4 is a schematic diagram of outputs or functions of a power management module. The power management module may include a switching power supply unit and/or a linear power supply unit. FIG. 4 shows a management module including two modes of power supply units. The adaptation for different voltages or different precision voltage outputs in the scene can be achieved by the two-mode power supply arrangement. Of course, it is not limited to only include these two modes of power supply units, it also can include an uninterruptible power supply (UPS), an inverter power supply, etc. In order to ensure that the detection system can expand the function or the power supply of the repairer during maintenance, the power management module also includes an expansion voltage output unit.

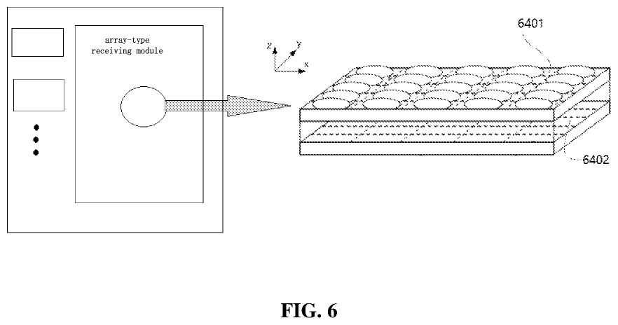

FIG. 5 illustrates the system includes a power management module in the single-photon avalanche diode detection mode under the DTOF detection method of a special detection system as an example which the power management module adopts the same integrated design as shown in FIG. 2. The power management module receives the input voltage of the battery and can convert the input voltage into various output voltages. For example, the power management module may output voltage V5, which may be the laser operating voltage. In order to ensure the adaptability to the scene, for example, the background light in the scene is particularly strong and the background light is particularly weak, etc., the output voltage V5 value needs to be adjustable, of course, the adjustment signal can be provided by the processing module or the control module, which is not limited here. The receiving end may include a selection module 530, in some special scenarios, the detection unit in the detector needs to work partially, then the selection module is driven by the voltage V1 to select a corresponding unit or a specific row. The receiving end may also include a clamping module 540 for active quenching after a single photon avalanche, for example, the operating voltage V2 for the clamping module may be a voltage value lower than the avalanche threshold, which may be 1-3V and so on, which is not limited here. In addition, the receiving end can also include an array-type photosensitive module 550 consisting of avalanche diodes, in order to make the detection unit in an avalanche state, the operating voltage V4 for the array-type photosensitive module 550 can be a voltage value higher than the avalanche threshold, of course, the system may contain other modules with special requirements, the power management module needs to output voltages with other voltage values, of course, in order to adapt to the noise effect caused by circuit heating, etc., the control module can obtain the temperature result at a specific position in the system and then generate a control signal to adjust the working voltage of the array detection module, of course, the adjustment may also be the driving voltage of the transmitting end is adjusted, which is not limited here. The communication interface of the receiving end and the communication interface of the transmitting end are denoted by reference numerals 510 and 520 respectively in FIG. 5, and the communication structure is also shared through the integrated design of the present disclosure, thus achieving the high efficiency and high integration design of the system, and simplifying the system complexity, although the independent power management module applied to the detection system can achieve functions in the design, the area of the entire system will increase, which will not achieve the requirements of the miniaturization and integration of the system. It may cause the entire system to fail to achieve user needs.

FIG. 6 shows a schematic layout diagram of a receiving end in the detection system of the present disclosure. The receiving end includes an array-type receiving module and a peripheral circuit with a peripheral layout, and the peripheral circuit may include an analog circuit and/or a digital circuit. The enlarged view of the array-type receiving module is shown on the right in FIG. 6, which includes a lens part 6401 and a base part of a detection unit 6402. The lens part includes a plurality of lens units, and the lens units can be consisted of micro-lens units with a predetermined curvature. The lens portion can include a structure with more than one layer to ensure maximum utilization of the returned light, and the specific implementation scheme is not limited here. In a better case, the base part 6402 can be set at the position of the focal plane corresponding to the lens part 6401, so as to ensure that the detection pixel unit can obtain accurate return light information to the greatest extent possible. In this case, the lens of the lens part 6401 can construct an optical channel, so that the signal received by the photosensitive part of the detection unit is near the corresponding focal position, the base part 6402 of the detection unit contains an array of photosensitive pixel arrays, and the photosensitive pixels can be formed by doping on the semiconductor base part 6402 to form CCD or CMOS and other types of photosensitive units, while all analog signal processing circuits, pixel level control circuits and analog-to-digital conversion circuits (ADCs) used in the readout of the pixel units can also include the semiconductor base part 6402. When the positional relationship of the circuits and the photosensitive units is arranged, front-illumination that the circuit layer is arranged on upstream the photosensitive unit which along the direction of returned light propagation, or back-illumination that the circuit layer is arranged on downstream the photosensitive unit which along the direction of returned light propagation, can be used. The specific implementation method is not limited here. Of course, the photosensitive unit and part of the circuit can be arranged in different semiconductor layers, and then the stacking process can be used to achieve a higher integrated design. Of course, the circuit arranged around this structure can include a power management module. One of the two similar packaging solutions shown in FIG. 2 can be used to form a modular structure of integrating the power management module, and the specific implementation solution is not limited here.

It should be noted that the terms “including”, “comprising” or any other variation thereof are intended to encompass a non-exclusive inclusion such that a process, method, article or device comprising a series of elements includes not only those elements, but also no other elements expressly listed, or which are also inherent to such a process, method, article or apparatus. Without further limitation, an element qualified by the phrase “comprising a . . . ” does not preclude the presence of additional identical elements in a process, method, article or apparatus that includes the element.

The above descriptions are only preferred embodiments of the present disclosure, and are not intended to limit the present disclosure. For those skilled in the art, the present disclosure may have various modifications and changes. Any modification, equivalent replacement, improvement, etc. made within the spirit and principle of this disclosure shall be included within the protection scope of this application. It should be noted that like numerals and letters refer to like items in the following figures, so once an item is defined in one figure, it does not require further definition and explanation in subsequent figures. The above descriptions are only preferred embodiments of the present disclosure, and are not intended to limit the present application. For those skilled in the art, the present application may have various modifications and changes. Any modification, equivalent replacement, improvement, etc. made within the spirit and principle of this application shall be included within the protection scope of this disclosure.

1. A detection system integrating a power management module, including:
an emitting end, where the emitting end includes a driver integrated circuit;
an integrated array-type receiving end, which includes at least some subsequent circuits, is used to receive the retuned light signals and then convert the light signals into electrical signals, where the retuned light is the emitting light from the emitting end and reflected by the detected object in the field of view; and
a power management module, which outputs at least the driving voltage required by the emitting end and the working voltage of the receiving array unit; the power management module and the driving integrated circuit or the array-type receiving end are integrated to form a modular structure.

2. The detection system integrating a power management module according to claim 1, wherein the power management module and the driver integrated circuit are integrated to form the modular structure, and the power management module and the driver integrated circuit are packaged into an integral modular structure.

3. The detection system integrating a power management module according to claim 1, wherein the power management module and the array-type receiving end are integrated to form the modular structure, and the power management module and the array-type receiving end are packaged into an integral modular structure.

4. The detection system integrating a power management module according to claim 3, wherein the receiving array unit is a single photon avalanche diode, and the working voltage of the receiving end output by the power management module is greater than the threshold voltage of the single photon avalanche diode.

5. The detection system integrating a power management module according to claim 2, wherein the driving voltage output by the power management module is adjustable.

6. The detection system integrating a power management module according to claim 3, wherein the working voltage of the receiving array unit output by the power management module is adjustable.

7. The detection system integrating a power management module according to claim 1, wherein the power management module further includes a common communication interface unit, and the communication interface unit is further configured to provide a communication connection for the driving integrated circuit or the array-type receiving end.

8. The detection system integrating a power management module according to claim 1, wherein the power management module further outputs at least a third output voltage with a third voltage value.

9. The detection system integrating a power management module according to claim 1, wherein the power management module includes a linear power supply unit.

10. (canceled)

11. (canceled)

12. The detection system integrating a power management module according to claim 1, wherein the power management module includes a switching power supply unit.

13. The detection system integrating a power management module according to claim 9, wherein the power management module further includes an extended voltage output unit.
